(19) United States
(12) Patent Application Publication
(10) Pub. No.: US 2005/0015268 A1
(43) Pub. Date: Jan. 20, 2005

(54) METHOD AND APPARATUS FOR DELIVERING BUILDING SAFETY INFORMATION

(76) Inventors: Ramon Diaz, South Pasadena, CA (US); Olga Diaz, South Pasadena, CA (US)

Correspondence Address: FOSTER, SWIFT, COLLINS & SMITH, P.C., 313 SOUTH WASHINGTON SQUARE, LANSING, MI, 48933, US

(21) Appl. No.: 10/711,288

(22) Filed: Sep. 8, 2004

Related U.S. Application Data
(63) Continuation-in-part of application No. 10/097,783, filed on Mar. 13, 2002.
(60) Provisional application No. 60/341,352, filed on Dec. 15, 2001.

(51) Int. Cl. G06F 17/60

(52) U.S. Cl. 705/1; 434/350

(57) ABSTRACT

An online, interactive emergency response training system designed to facilitate the dissemination of safety preparedness information for natural and man-made emergencies, including, but not limited to: fire, earthquake, bomb, medical, and power failure is hereby disclosed. Additionally, various other methods of disseminating said safety preparedness information are also disclosed.

### PRIORITY

This application is a continuation-in-part of U.S. application Ser. No. 10/097,783, filed on Mar. 13, 2002; which claims priority to U.S. provisional application No. 60/341,352, filed on Dec. 15, 2001.

### FIELD OF THE INVENTION

A method of automating and personalizing the delivery of property-specific building safety information to occupants of commercial buildings.

### BACKGROUND OF THE INVENTION

In today's commercial real estate market, many buildings share common management even when not commonly owned. In certain circumstances, a building owner, particularly one with fewer properties, may determine it is more advantageous to hire a third-party management company than to manage the properties in-house. This often produces greater managerial efficiency in that a single large management company can deploy building managerial services more efficiently across a large number of properties than can a building owner with few properties. These services may include, advertising, prospective tenant screening, maintenance, janitorial services, and the like. Consequently, many commercial buildings, particularly hi-rise, Class A, Class B, and Class C buildings, are wholly managed by a third-party management company. It is not unusual for larger management companies to manage hundreds if not thousands of buildings nationwide.

It is also common for a real estate holder with many properties to create a company to manage only its buildings. Oftentimes, such holders are institutional investors or real estate investment trusts (REITs). These holders may have sufficient properties to enjoy the same economies of scale of a large third-party management company.

A goal of professional property management is to manage the day-to-day aspects of the property that will minimize occupant turnover and maximize occupancy rates. To ensure maximum occupancy rates, property management must be responsive to the needs of the tenant, including the timely and efficient operations of parking, climate control, building access, electrical, plumbing, security, and safety systems. As a practical matter, many of these services are outsourced to minimize overhead and to take advantage of the economies of scale inherent in a shared resource.

One direct or subcontracted property management service is to provide building safety information and training. In every major metropolitan area within the United States, commercial buildings are subject to safety codes imposed by federal, state, and local governments. These safety codes are intended to protect the health, safety, and general welfare of the American people. Each lower level of government adds safety requirements that reflect the unique and often incompatible safety concerns of the geographic locale. For example, communities in the southeast U.S. might be particularly concerned with hurricanes, while hurricanes are almost non-existent on the west coast of the U.S.

Presently, most municipalities require each occupant of a commercial building receive safety training regarding the emergency procedures in place to deal with a variety of situations, such as fire and earthquake. This safety training responsibility may fall on either the tenant, the building manager, the building owner, or any combination thereof.

Certain factors make it particularly difficult for owners and management companies to comply with safety training requirements, including:
(1) the uniqueness of each building;
(2) the ongoing training requirement; and
(3) the diversity of safety codes with which to comply.

A challenge for a large management company is to develop training requirements unique to each building using a business model predicated on the ability to provide the nearly undifferentiated service to numerous clients to maximize economy of scale. Yet safety training must be tailored to each building to be effective. Even identical buildings located in different areas will often mean different safety codes with which to comply.

Additionally, once a compliance program is implemented, each occupant within the building must be trained in a timely basis on the emergency response procedures. Unfortunately, a large building may have a multitude of tenants, each with a revolving door of employees or occupants. Not only must each occupant be trained, but a record of the training should be preserved for auditing and compliance purposes.

Various business entities have attempted to solve this issue with varying success. Nevertheless, this field is an emerging market with no dominant player. Most participants are usually providers of other commercial services such as building security and perform building emergency response planning training as an ancillary service for their clients.

The reality though is that many businesses do not fully comply with the safety rules, specifically, those instructions tailored to the unique aspects of a particular building. The resultant compliance is thus frequently haphazard, and oftentimes the local municipalities find numerous violations upon audit.

There is thus a desire and a need in the art to provide an efficient and effective tool to allow those responsible to comply to various safety regulations. The economics of such system are wide reaching. For example, an indirect benefit to complying effectively is in reduced insurance costs. Property owners and managers almost always carry property casualty insurance and general liability insurance on their properties. These premiums tend to be expensive due to high property replacement value and potential for various personal injuries. Insurance companies have long given premium reductions when its insured can demonstrate that its likelihood of losses can be mitigated through preparedness or preventative measures.

### SUMMARY OF THE INVENTION

Accordingly, it is an important aspect of the invention to provide a method of automating and personalizing the delivery of property-specific building safety information to occupants of commercial buildings.

Specifically, the present invention represents an exemplary system for assisting in the mitigation of losses, both human and financial, by educating and training the occupants of commercial buildings to be prepared for earthquakes, fires, medical emergencies, power failures, etc. thereby enhancing the probability of reducing the number of fatal and non-fatal injuries in commercial buildings. This reduction in the building's risk profile should qualify the building for an insurance premium reduction.

Additional aspects and advantages of the invention will become apparent from the following detailed description, the drawings, and the appended claims.

### BRIEF DESCRIPTION OF THE FIGURES

The foregoing features, as well as other features, will become apparent with reference to the description and figures below, in which like numerals represent like elements, and in which:

FIG. 1 represents a flow diagram of the preferred embodiment of this invention;

FIG. 2 represents a flow diagram of the preferred embodiment of this invention;

FIG. 3 represents a flow diagram of the preferred embodiment of this invention;

FIG. 4 represents a flow diagram of the preferred embodiment of this invention;

FIG. 5 represents a flow diagram of the preferred embodiment of this invention;

FIG. 6 represents a flow diagram of the preferred embodiment of this invention; and

FIG. 7 represents a flow diagram of the preferred embodiment of this invention.

### DETAILED DESCRIPTION OF THE INVENTION

The present invention generally relates to a method of automating and personalizing the delivery of property-specific building safety information to occupants of commercial buildings.

The present invention method and apparatus allows for automated delivery of personalized building safety procedures or information in a timely manner to all occupants of commercial buildings. By way of example only, one embodiment of the present invention may be demonstrated using the following steps:
(1) Identification of buildings that would benefit from the delivery of said information;
(2) Obtaining building-specific fire and life safety systems information from the appropriate persons;
(3) Developing a customized emergency response plan (ERP) for the occupants of each building;
(4) Creating a customized multi-media presentation unique to each building;
(5) Delivering the content to the occupants of the buildings;
(6) Providing interactive testing of material in presentation; and
(7) Retaining results of the interactive session for accounting, legal, human resources, and risk management compliance.

The illustrated embodiment of the present invention, and without limitation to other embodiments, will most likely benefit the “hi rise”, Class A, Class B, and Class C buildings that are managed by large management companies. These buildings are most likely to be found in downtown or central business districts of major metropolitan areas. Optionally, buildings utilizing the present invention should have fast data-transfer capabilities, such as the latest telecommunications, broadband connectivity, Internet, DVD, CD-ROM, video, and the like, either alone or in various combinations known in the art.

Once a building has been selected, the safety specifications may be obtained from any authorized person such as the property manager, building or safety engineer, fire marshal, building security personnel, building owners, and the like. An interactive multi-media presentation that would include all of the relevant emergency response procedures including earthquake, fire, medical emergencies, power failures, etc. could then be developed. This instruction can be tailored to instruct several audiences. For example, a “staff training” module may be created for staff members only. This module could instruct building staff members what to do in case of these emergencies. Also, floor wardens could have a module to review their responsibilities during an emergency or alarm. All building occupants could have a module for practicality since it is very difficult for building management to monitor each occupant. This general module would instruct the individual occupant of what to do during an emergency. A module could even be developed to make the presentation not only site specific but also tailored solely for the engineering team. Thus, if a building engineer who knows everything about the building leaves his job, his replacement may use the program to learn the buildings systems and equipment.

In one embodiment, the presentation would be interactive, including functionality for VCR-type controls, hypertext links, and the like. The content of each presentation is unique to each building. The presentation may be developed using information received by a one-on-one, personal interview/building walk through process at the particular building, as well as discovering what each local city and fire department requirements were for the building. Use of a building's emergency procedures manual could also be used. If none was in place, such a procedure manual could be developed from interviews with a building manager, engineer and security personnel about their building's fire/life safety systems and procedures. This information could then be placed into an emergency procedures manual for building staff to use for training. A condensed version of this manual could be customized for floor wardens. Then an extremely condensed version of the manual is made for building occupants.

The information compiled above could then be programmed into various desired presentations, such as the “occupant emergency procedures online presentation.” The program itself could contain the entire database of information that could be filtered based on the user. That is, the occupant presentation would be set to filter only relevant information needed by the occupant. A database of local codes, rules and regulations could be developed and used by the company compiling the online presentation. Any computerized storage devices known in the art, such as CD-ROM, DVD-ROM, flash drive, zip drive, and the like may be utilized.

By way of example only, in one embodiment of the present invention the presentation is delivered via the Internet using broadband access, which would permit a multi-media presentation. In alternate embodiments, the presentation could reside on a user's server or work station. Alternatively, the presentation may be provided to the user on mass storage devices including, but not limited to, video, CD-ROM, DVD-ROM, zip disk, flash drive, and the like. Also, the presentation may be provided to the user via audio-visual equipment, including, but not limited to, video cassettes and DVD.

Once a user has reviewed the presentation, testing could be conducted using the same technologies. In one embodiment of the invention, testing could be interactive wherein after the presentations, the user could take a safety awareness test online. Incorrect answers could result in a replay or review of selected portions of the presentation and the question repeated until a correct answer was provided. This replay could occur either manually or automatically. In an alternate embodiment, testing could be accomplished through a telephone response system where the user would verify themselves then select answers to a multiple-choice questions using the telephones numeric keypad.

The invention could optionally include a standard password and user identification (ID) authentication system. Revenue is achieved through any combination of the following: creating the safety presentation, maintaining the presentation, updating the presentation as necessary, usage of the system, and record keeping.

### DESCRIPTION OF THE SPECIFIC EMBODIMENTS

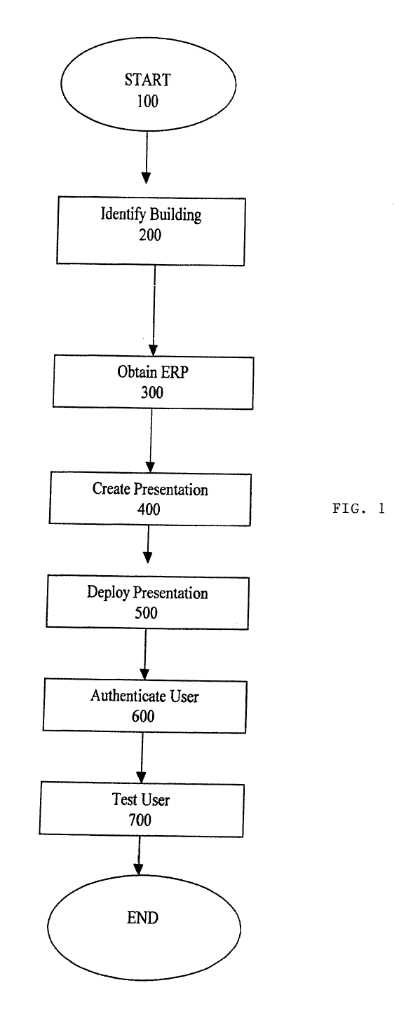

Referring to FIG. 1, the system starts at step 100. At step 200, an appropriate building for the system is identified. At step 300, the system obtains an emergency response plan (ERP) configured to be suitable for the geographic location of the building and building type. At step 400, the system creates or assembles a customized presentation utilizing the emergency response plans. At step 500, the presentation is deployed or otherwise made available to the user. If the user (customer) wishes the information to be stored on the developer's or third party server, a web-site address could be given to the user so that, for example, a new employee having a particular login and/or password for their building could access information relevant for that employee. Commonly in the art, an employee could sign-on to the host web site, insert his name (or company employee number, etc.) where asked to do so, along with a password. Then the presentation for their building launches on their computer using, for example, flash technology. The new employee launches the presentation, takes the test, then logs out.

At step 600, the system authenticates the new users' names or employees' numbers pre-provided to the host and passwords are issued to each name or a blanket password for the entire company. The user determines the appropriate presentation to execute. At step 700, the presentation is executed, the user tested and the results stored. For example, at the end of the presentation, a test could be given (e.g., multiple choice). The new employee chooses answers and if employee passes with 100 percent accuracy, that employee passes. If not 100 percent, the new employee can go back to review that particular section and re-answer the question correctly and the test results tabulated. The program may have an administrative side whereby if the building manager is responsible to ensure the training is being done, the building manager may log onto the host website, put in their password, and access the names and scores of all new employees that have watched the presentation. There may also be an option to capture a list of those who have not viewed the presentation for accountability and liability purposes.

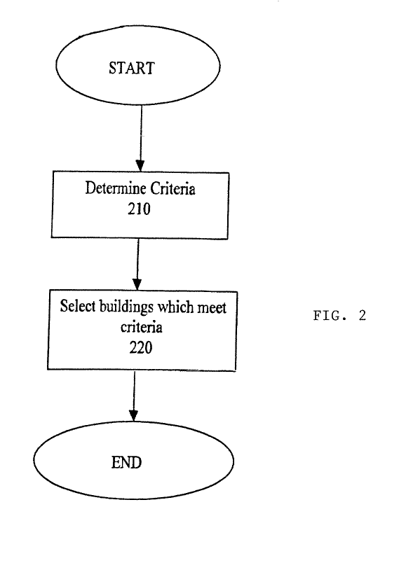

Referring to FIG. 2, at step 210, the system selects a set of criteria that determines the several classes of properties whose occupants would benefit from the system. At step 220, properties and the system criteria are matched to select potential buildings to deploy the system.

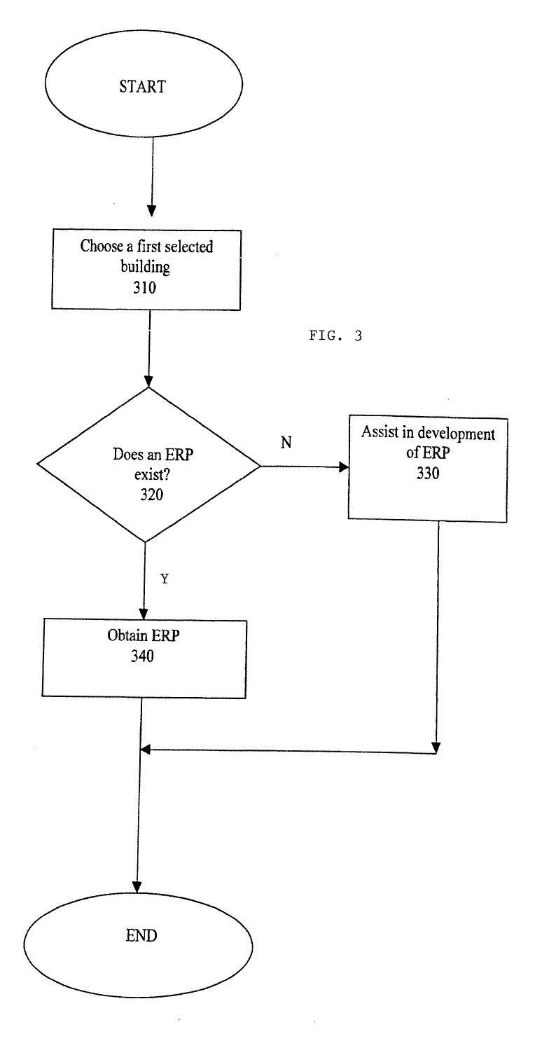

Referring to FIG. 3, at step 310, a potential building is selected. At step 320, the system inquires whether an ERP currently exists for the property. If an ERP exists, the system obtains it at step 340, otherwise the system assists in the creation development of an ERP at step 330.

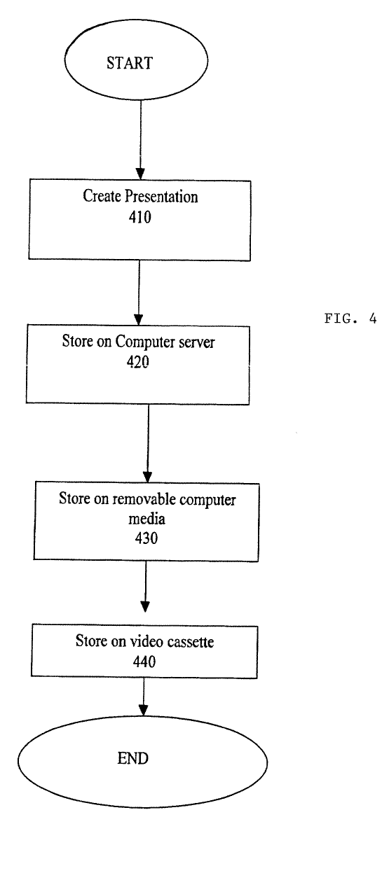

Referring to FIG. 4, at step 410, the system creates a multi-media presentation incorporating the ERP. At step 420, the presentation is stored on a computer server. Alternatively, the presentation is stored on a removable computer media such as, but not limited to, a CD-ROM or DVD-ROM. Alternatively, the presentation is stored on a video cassette.

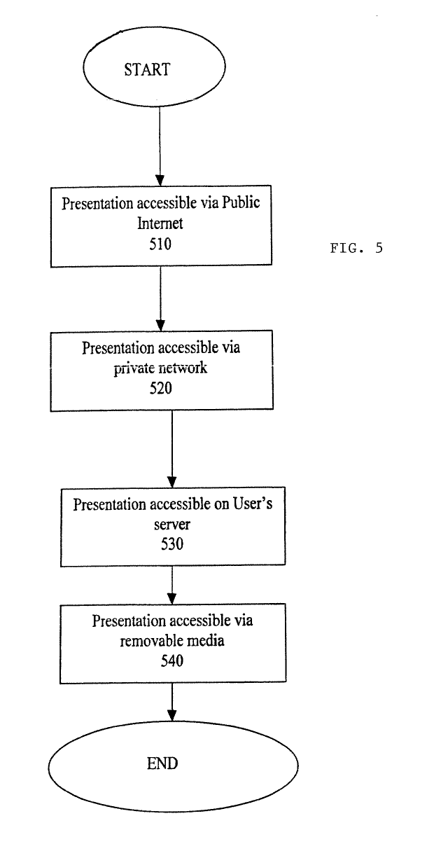

Referring to FIG. 5, at step 510, the system makes the presentation accessible over the public Internet. Alternatively, at step 520, the presentation may be accessible via a virtual private network (VPN), DVD, CD-ROM, video, flash drive, zip drive, and the like. Alternatively, at step 530, the presentation is accessible locally through the user's server.

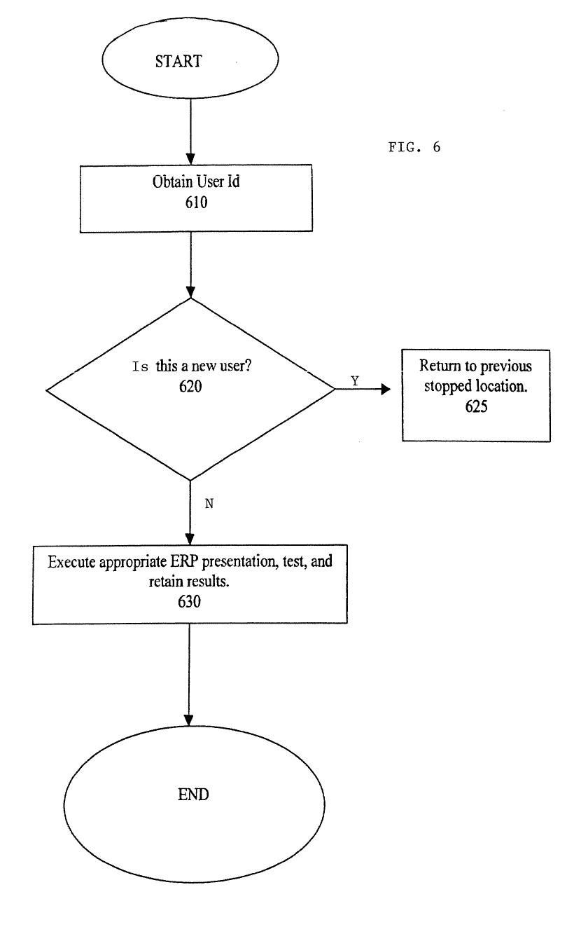

Referring to FIG. 6, at step 610, the system obtains a user ID and determines whether the user is a new user. The customer provides the host server with a name, which is then assigned password. The system can flag whether the user has ever logged into the system in the past and assign the label of new or return user. If the user is a returning user, at step 625 the system continues where the user previously finished. Should the user be a new user, at step 630, the system executes the appropriate ERP presentation.

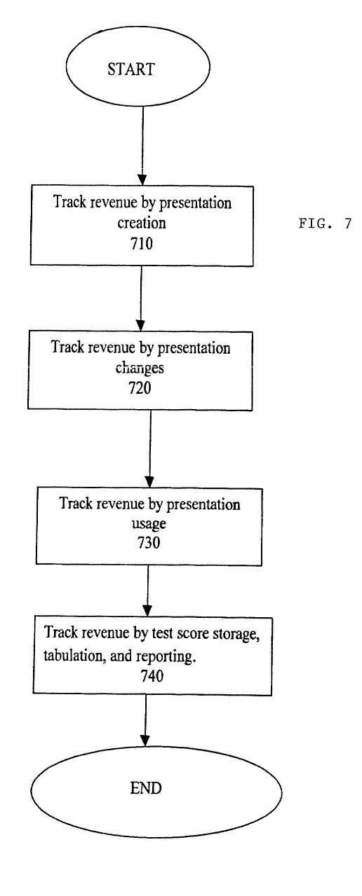

Referring to FIG. 7, at step 710, the system tracks revenue based upon cost to create the presentation. This administrative option could allow comparison of how many people in the high-rise were using the program and thus be able to calculate cost to the owner/manager to use the product (i.e., $1.00/person). At step 720, the system tracks revenue based upon any user requested changes to the presentation. At step 730, the system tracks revenue based upon usage of the presentation. At step 740, the system tracks revenue based upon test score storage, tabulation, and reporting. Different task specific routines or modules may be developed to accomplish these tasks using software known by those skilled in the art.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

1. A computerized method of delivering building safety information comprising:
(a) identifying a suitable building where the deployment of building safety information can be done in an efficient, cost-effective manner;
(b) obtaining the emergency response plans;
(c) creating a customized emergency response presentation;
(d) delivering the presentation to a building occupant;
(e) authenticating the occupant of the presentation;
(f) testing the occupant; and
(g) retaining the authentication data and test results.

2. The method of claim 1, step (a), where the suitable buildings are identified as Hi-rise Class A, Class B or Class C buildings.

3. The method of claim 1, step (a), where suitable buildings are identified as located in central business districts or suburban areas of major metropolitan cities.

4. The method of claim 1, step (a), where the suitable buildings are identified as having current telecommunications capabilities.

5. The method of claim 1, step (c), where the emergency response presentation is an audio-visual presentation.

6. The method of claim 5, where the audio-visual presentation is created as an interactive computerized multi-media presentation.

7. The method of claim 5, where the audio-visual presentation is created as non-interactive format.

8. The method of claim 1, step (d), where the presentation is deployed via the public Internet.

9. The method of claim 1, step (d), where the presentation is deployed over a private area network.

10. The method of claim 1, step (d), where the presentation is deployed on a customer's server.

11. The method of claim 1, step (d), where the presentation is deployed using removable media.

12. The removal media of claim 11, where the removal media is a flash drive.

13. The method of claim 1, step (f), where the testing occurs after completion of the presentation.

14. The method of claim 1, step (f), where the testing occurs online.

15. The method of claim 1, step (f), where the testing occurs via telephone.

16. A system for deploying emergency response preparedness information comprising:
(a) at least one server configured to host the emergency safety response multi-media presentations;
(b) a network configured to transmit the emergency safety response multi-media presentations; and
(c) at least one computer connected to said network.

17. The server of claim 16 where the server can run several multi-media presentations simultaneously.

18. The server of claim 16, where the server is configured to authenticate each user, wherein said authentication is used to determine which multi-media presentation is accessed.

19. The server of claim 16, wherein the server is configured to administer an emergency response preparedness test.

20. The server of claim 1 9, where the server is configured to store the results of each test.

21. The server of claim 20, where the server is configured to tabulate test results.

22. The network of claim 16, step (b), where the network is the public Internet.

23. The network of claim 16, step (b), where the network is a proprietary network.

24. The computer of claim 16, step (c), where the computer is configured to have access to the network of claim 16, step (b).

25. The computer of claim 16, step (c), where the computer is located at a recipient's place of business.

26. The computer of claim 16, step (c), where the computer is located in a public testing center.

27. The computer of claim 16, step (c), where the computer is located on the same private network as the server.

28. A revenue management system configured to track system usage comprising:
(a) a first module configured to track revenue generated from the creation of an emergency safety response presentation;
(b) a second module configured to track revenue from client initiated changes to said presentation;
(c) a third module configured to track system usage by clients;
(d) a fourth module configured to track record keeping; and
(e) a fifth module configured to summarize the record keeping information.
